(19) United States
(12) Patent Application Publication
(10) Pub. No.: US 2009/0211260 A1
(43) Pub. Date: Aug. 27, 2009

(54) Multi-Spool Intercooled Recuperated Gas Turbine

(75) Inventors: James B. Kesseli, Greenland, NH (US); Thomas L. Wolf, Winchester, MA (US); James S. Nash, North Hampton, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(73) Assignee: BRAYTON ENERGY, LLC, Hampton, NH (US)

(21) Appl. No.: 12/115,134

(22) Filed: May 5, 2008

Related U.S. Application Data
(60) Provisional application No. 60/927,342, filed on May 3, 2007.

(51) Int. Cl. F02C 7/26

(52) U.S. Cl. 60/786; 60/792

(57) ABSTRACT

A method and apparatus are disclosed for a gas turbine power plant with a variable area turbine nozzle and an integrated motor/alternator device for starting the gas turbine and power extraction after starting.

### CROSS-REFERENCE TO RELATED APPLICATIONS

This application claims the priority benefit under 35 U.S.C. § 119(e) of U.S. provisional patent application No. 60/927,342 filed May 3, 2007. The aforementioned provisional application is herein incorporated by reference in its entirety.

### BACKGROUND

The present development relates generally to turbo machines and, more particularly, multi-spool intercooled recuperated gas turbine systems and methods. The system and method are particularly adapted for use as a power plant for a vehicle, especially a truck, bus or other overland vehicle. However, it will be appreciated that the present disclosure has broader applications and may be used in many different environments and applications, including as a stationary electric power module for distributed power generation.

Vehicular bus or truck applications demand a very wide power range of operation. The multi-spool configuration described in this disclosure creates opportunities to control the engine to a very low power range.

Typical multistage gas turbine engines incorporate a coaxial stack of turbines and compressors, thereby making a compact axial machine, with minimized frontal area.

A conventional gas turbine may be composed of two or more turbo compressor rotating assemblies to achieve progressively higher pressure ratio. A turbo machine composed of three independent rotating assemblies or “spools,” including a high pressure turbo compressor spool 10, a low pressure turbo compressor spool 9, and a free turbine spool 12 appears in FIG. 1. As seen in FIG. 1, the high pressure spool 10 is composed of a compressor 22, a turbine 42, and a shaft 16 connecting the two. The low pressure spool 9 is composed of a compressor 45, a turbine 11, and a shaft 18 connecting the two. The free turbine spool 12 is composed of a turbine 5, a load device 6, and a shaft 24 connecting the two. Said load device is normally a gearbox, generator, or a transmission for a vehicular application. A combustor 41 is used to heat the air between the recuperator 44 and high pressure turbine 42.

A common method for starting a turbo machine is seen in FIG. 2 and provides electro-mechanical motive power to the high pressure spool 10. A motor/clutch 13 is engaged to provide rotary power to the high pressure spool 10. Once the high pressure spool 10 is supplied with power, air flow within the cycle occurs, enabling the fuel to be admitted into the combustor and the subsequent initiation of combustion. Hot pressurized gas from the high pressure spool 10 is delivered to the low pressure spool 9 and the free turbine spool 12. The present apparatus contemplates new methods for starting a turbo machine and efficiently operating at low power levels.

### SUMMARY

The present disclosure describes an apparatus and method for starting and/or extracting power from a gas turbine engine and a turbo machine employing the same. In certain embodiments the introduction of a pressurized motive fluid such as air or hydraulic fluid to a starter turbine on the high pressure spool provides the starting power for the gas turbine. The starter turbine can be a separate turbine on the high pressure spool or may be provided by buckets or blades machined into or otherwise formed or provided on the rotor of the compressor. In other embodiments, a motor/alternator combination is incorporated with the high pressure spool. The addition of a motor/alternator combination to the gas turbine's high spool 10 provides the means for both starting the gas turbine and extracting a small amount of power during engine operation. For example, the combined motor alternator device may be coupled to the electrical system of a vehicle such that the vehicle power supply may be used to operate the motor/alternator device for starting the gas turbine and, after the gas turbine has been started, for converting a portion of the rotational power of the high pressure spool to electrical power.

In certain embodiments, efficiency is also increased by the addition of a variable area turbine nozzle between a low pressure turbo compressor spool and a free turbine spool. The variable area turbine nozzle allows the user to have control over the level of fuel consumption enabling the user to lower the fuel consumption by the gas turbine.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 depicts a turbo machine composed of three independent spools, two nested turbo compressor spools and one free turbine spool connected to a load device.

FIG. 2 illustrates an apparatus and method for starting the turbo machine, providing electro-mechanical motive power to the high spool turbo compressor.

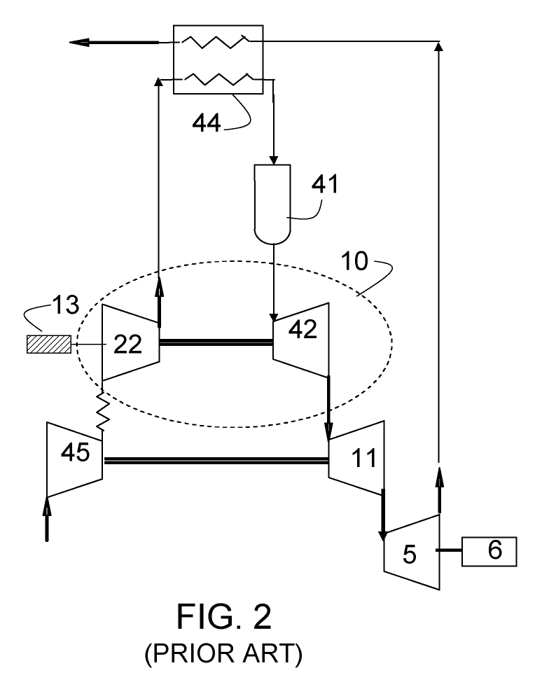

FIG. 3 illustrates an apparatus and method for starting the gas turbine by providing pneumatic power to the high spool turbo compressor.

FIG. 4 illustrates an apparatus and method of integrating an air starter turbine into the back face of the compressor impeller.

FIG. 5 illustrates an electric motor/generator combination, connected to the highest pressure turbo compressor spool.

FIG. 6 illustrates yet another variation on the integrated high spool motor generator.

FIG. 7 illustrates an apparatus and method for combining a high speed permanent magnetic alternator into the shaft of a turbo compressor spool.

### DETAILED DESCRIPTION OF THE PREFERRED EMBODIMENTS

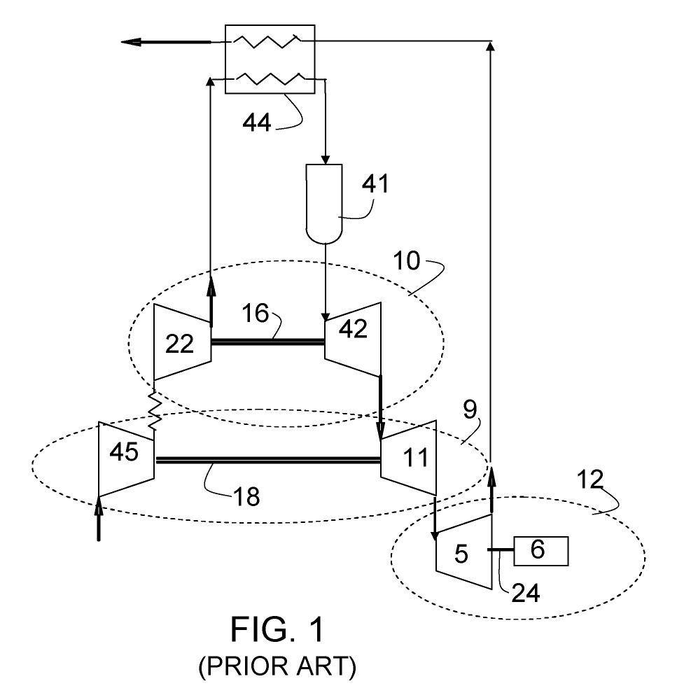

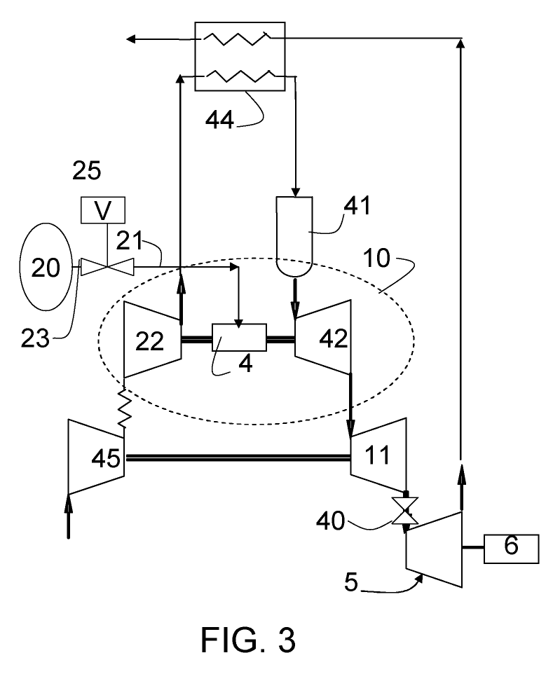

Referring to the drawings, wherein like reference numerals refer to like or analogous components throughout the several views, FIG. 3 illustrates an apparatus and method of starting a multi-spool gas turbine which may generally be of the type appearing in FIG. 1, by providing pneumatic or hydraulic power to the high spool turbo compressor 10. In certain embodiments, a vessel 20 contains a high pressure gas such as air, which is delivered through conduits 23 and 21, having a control valve 25 therebetween, to a starter turbine 4, which may be a gas turbine affixed to the shaft 16 of the turbo compressor spool 10.

In alternative embodiments, the conduit 23, valve 25, and conduit 21 may supply hydraulic fluid as the motive fluid to the starter turbine 4, which may alternatively be a hydraulic turbine affixed to the shaft 16 of the turbo compressor spool 10. It is preferable to employ air as the motive fluid for the turbine 4 rather than hydraulic fluid in those embodiments wherein the turbine 4 is supported on air bearings. Likewise, it is preferable to employ conventional, oil lubricated bearings in place of air bearings when the motive fluid is a hydraulic fluid.

The valve 25 may have a controller for selectively opening the valve to permit passage of the pressurized fluid in the container 20 to the starter turbine 4 in response to a control signal, such as a signal to start the gas turbine engine. When the valve 25 is opened, e.g., in response to a control signal from the valve controller, the motive fluid travels via the conduit 21 to the starter turbine 4. The turbine 4 may be affixed or integrated with the turbo compressor spool 10 without the need for additional bearings or couplings. The motive fluid delivered to the turbine 4 imparts angular momentum to rotate the high spool turbo compressor 10. As the turbo compressor spool 10 rotates, it creates flow within the low pressure turbo compressor spool 9 and the turbo alternator spool 12 of the turbo machine.

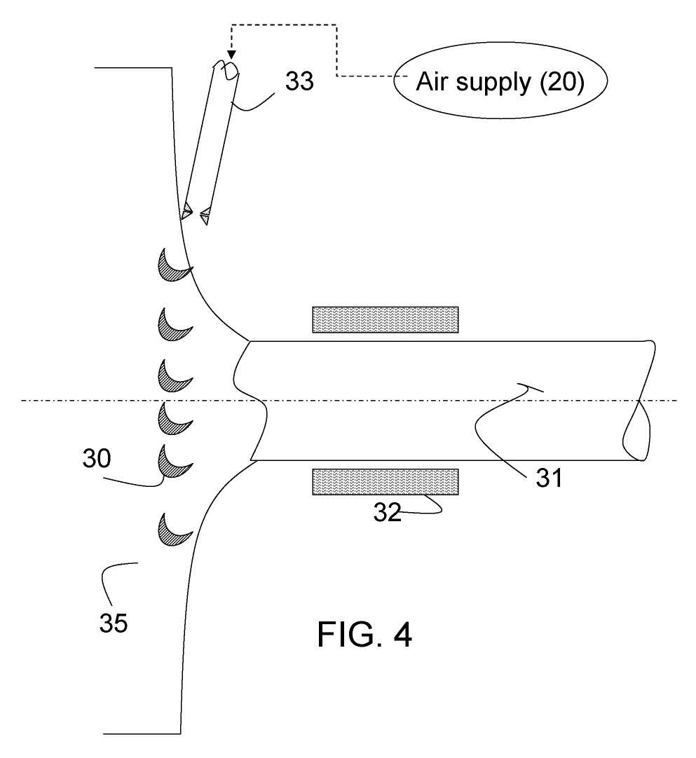

Referring now to FIG. 4, there is shown a fragmentary view of an exemplary embodiment of the present development wherein the turbine 4 is and air or gas turbine supported on a shaft 31 which, in turn, is rotatably supported on air bearings 32. The turbine 4 may be integrated with a compressor impeller 35 of the compressor 22 by milling or otherwise forming or providing small turbine buckets 30 on or in the back face of the compressor impeller 35, as shown in FIG. 4. The addition of the turbine buckets 30 enables the compressor 35 to more productively use the high pressure air supplied from the air supply 20 and air nozzle 33. As the air enters the compressor 35, the turbine buckets 30 catch the air and turn the turbo compressor shaft 31 to start the gas turbine.

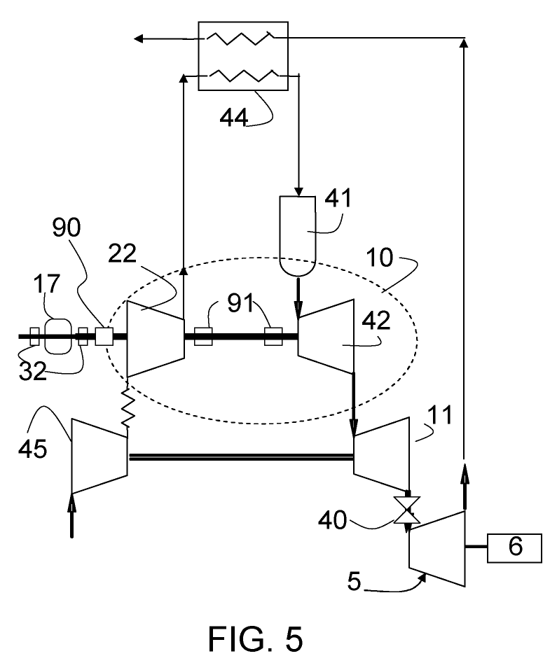

FIG. 5 illustrates a further embodiment wherein an electric motor/alternator combination 17 is combined with a high pressure turbo compressor spool 10, which may otherwise be as described above. The motor/alternator combination 17 provides a means for starting the gas turbine as well as the option of extracting a small amount of power (for example, less than about 5% of the power output of the gas turbine) during engine operation. This small amount of extracted power provides a means of controlling the speed of high spool turbo compressor 10 while the engine operates at minimum power near the idle point. The relatively small amount of electric power generated is well suited for vehicular auxiliary electric system loads, independent of drive power needed for the vehicle.

Also shown in FIG. 5, is an exemplary method of power take off for a single spool gas turbine engine, which requires the coupling of the motor/alternator 17 at the inlet end of the compressor shaft. Single spool gas turbines, configured as a turbo compressor alternator assembly require a mechanical coupling to connect the turbo compressor 10, operating on its main bearings 91, to the alternator load, operating on its bearings 32. In such an embodiment the turbo compressor 10 and the alternator 17 are installed on their own bearings 91 and 32, respectively, with a coupling 90 employed to connect the two rotating machines. In certain configurations, the coupling 90 may incorporate a mechanical clutch or mechanism typically used to engage and disengage the starting device.

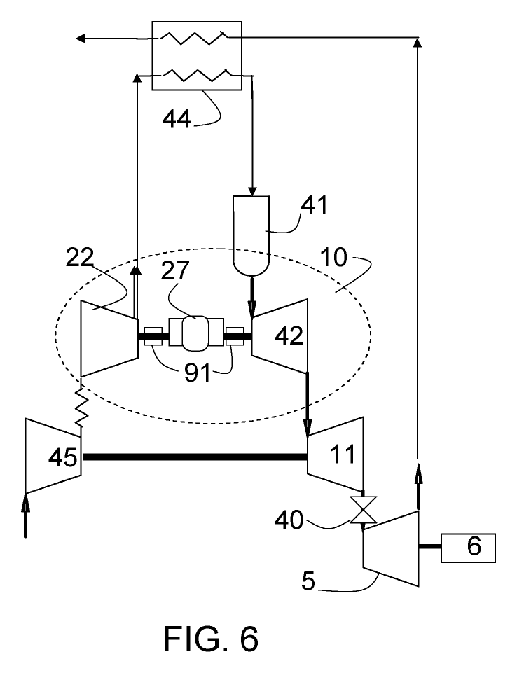

In the present disclosure, referring to FIG. 6, due to the small fraction of the turbine power devoted to the load, the size of the alternator 27 is relatively small when compared to alternators driven by gas turbines. For this reason, a compact shaft-speed alternator may be installed on the turbine alternator spool 10 without separate bearings and couplings. For example, a samarium-cobalt type permanent magnet alternator is small enough to fit within a hollow portion of the shaft, either between the compressor 22 and turbine 42 or overhung from the compressor inlet. FIG. 6 illustrates a variation on the integrated high spool motor/generator device, incorporating a compact motor/alternator combination 27 between the turbine 42 and the compressor 22. The terms “generator” and “alternator” are used interchangeably herein unless specifically stated otherwise.

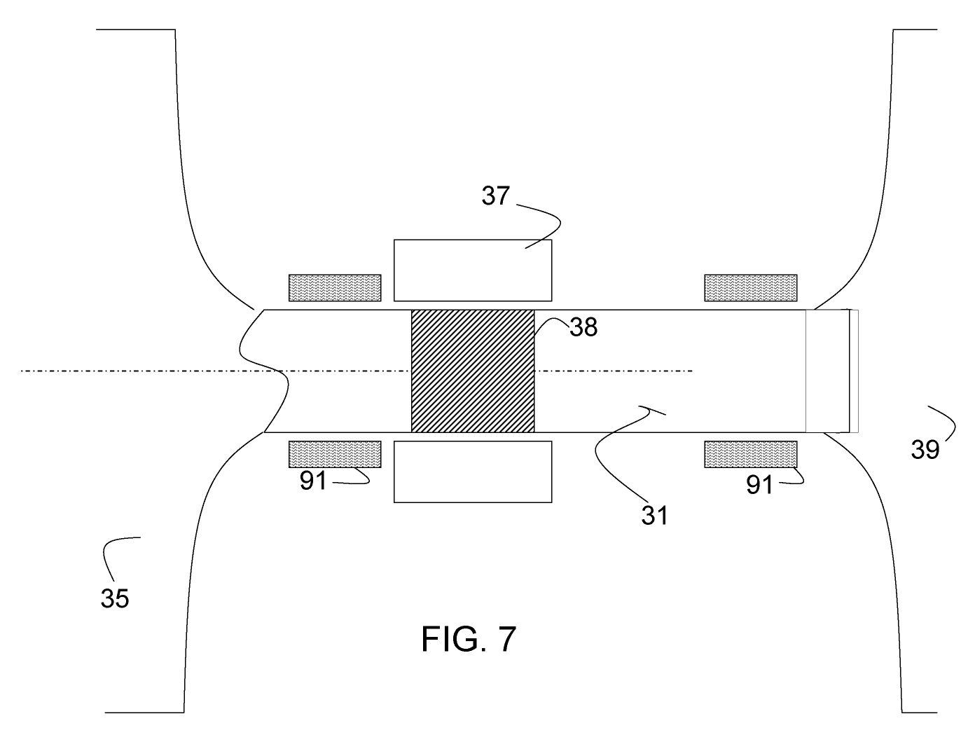

FIG. 7 shows an alternative embodiment integrating a magnetized motor/alternator 38 into the high spool turbo compressor 10. A hollow shaft 31, which connects a compressor rotor 35 and a turbine rotor 39, rotates on main bearings 91. Due to the small accessory load absorbed by the alternator rotor 38 and small starting power required from the motor 38, the magnetized rotor 38 is contained inside the hollow shaft 31. Electrical stator components 37 surround the magnetized alternator/motor rotor 38 assembly. In an alternative embodiment, an alternate mechanical configuration, employing theses same components, may be arranged with the alternator rotor 38 and the alternator stator 37 in front of or integral with compressor 35, employing a single pair of main bearings 91.

Exemplary embodiments of the present invention showing the location of a variable area turbine nozzle 40 are seen in FIGS. 3, 5 and 6. Although the gas turbine embodiments herein may operate with a conventional fixed geometry turbine nozzle, the use of a variable area turbine nozzle 40 is advantageous in that it enables an additional control feature to lower fuel consumption by controlling the rate of flow of air to the turbine 5 of the free turbine spool 12. The ability to lower fuel consumption makes the present development more efficient.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiments, the invention is now claimed to be:

1. A gas turbine engine, comprising:
a high pressure spool having a high pressure compressor, a high pressure turbine, and a first rotatable shaft rotatably coupling the high pressure compressor and the high pressure turbine on a first pair of bearings;
a low pressure spool having a low pressure compressor, a low pressure turbine, and a second rotatable shaft rotatably coupling the low pressure compressor and the low pressure turbine;
a combustor for receiving a high pressure airflow from the high pressure compressor and delivering a heated airflow to the high pressure turbine to rotatably drive the first shaft and the high pressure compressor;
a free turbine spool comprising a free turbine and a free turbine shaft, said free turbine shaft rotatably coupling said free turbine to a load device selected from a mechanical load and an electrical load;
said high pressure turbine delivering a first reduced pressure airflow to said low pressure turbine to drive said second shaft and said low pressure compressor;
said low pressure turbine delivering a second reduced pressure airflow to said free turbine to drive said load device; and
a starter device for causing the rotation of said high pressure spool, said starter device integrally built into one or both of said first shaft and said high pressure compressor.

2. The gas turbine engine of claim 1, further comprising:
a heat exchanger; and
said free turbine delivering a third reduced pressure airflow to said heat exchanger for transferring heat from said third reduced pressure airflow to said high pressure airflow from said high pressure compressor.

3. The gas turbine engine of claim 1, further comprising:
said started device having a starter turbine and a source of motive fluid selectively fluidically coupled to said starter turbine for selectively delivering a motive fluid flow to said starter turbine; and
a valve controlled by a controller, said controller for generating a control signal, said valve configured to open and deliver said motive fluid to said starter turbine to start said gas turbine engine in response to said control signal.

4. The gas turbine engine of claim 3, where said motive fluid is selected from air and a hydraulic fluid.

5. The gas turbine engine of claim 1, wherein said high pressure compressor includes a rotor and said starter device includes a starter turbine including turbine buckets or turbine blades integrated with said rotor for causing rotation of the rotor in response to receiving a flow of said motive fluid.

6. The gas turbine engine of claim 5, wherein said motive fluid is air, said gas turbine engine further comprising air bearings on said first shaft supporting said starter turbine.

7. The gas turbine engine of claim 6, wherein said high pressure compressor includes a compressor impeller having an impeller face, a back face opposite the impeller face, and a plurality of turbine buckets formed on the back face, said turbine buckets adapted to cause rotation of the compressor impeller in response to receiving a flow of said air.

8. The gas turbine engine of claim 1, wherein said load device is connected to said free turbine, said load device selected from an alternator and a geared transmission.

9. The gas turbine engine of claim 1, further comprising:
said free turbine including a variable area turbine nozzle for controlling fuel consumption.

10. A gas turbine engine, comprising:
a high pressure spool having a high pressure compressor, a high pressure turbine, and a first rotatable shaft rotatably coupling the high pressure compressor and the high pressure turbine on a first pair of bearings;
a low pressure spool having a low pressure compressor, a low pressure turbine, and a second rotatable shaft rotatably coupling the low pressure compressor and the low pressure turbine;
a combustor for receiving a high pressure airflow from the high pressure compressor and delivering a heated airflow to the high pressure turbine to rotatably drive the first shaft and high pressure compressor;
a free turbine spool comprising a free turbine, and a free turbine shaft rotatably coupling said free turbine to a load device selected from a mechanical load and an electrical load;
said high pressure turbine delivering a first reduced pressure airflow to said low pressure turbine to drive said second shaft and said low pressure compressor;
said low pressure turbine delivering a second reduced pressure airflow to said free turbine to drive said load device; and
a combined motor and alternator device on said high pressure spool operable to drive said first rotatable shaft for starting said gas turbine engine, said combined motor and alternator device further operable to convert rotational energy of said first rotatable shaft to electrical energy.

11. The gas turbine engine of claim 10, further comprising:
a heat exchanger; and
said free turbine delivering a third reduced pressure airflow to said heat exchanger for transferring heat from said third reduced pressure airflow to said high pressure airflow from said high pressure compressor.

12. The gas turbine engine of claim 11, wherein said load device is connected to said free turbine, said load device is selected from an alternator and a geared transmission.

13. The gas turbine engine of claim 12, wherein said combined motor and alternator device is supported on said first rotatable shaft.

14. The gas turbine engine of claim 13, further comprising:
air bearings supporting said combined motor and alternator device on said first rotatable shaft.

15. The gas turbine engine of claim 10, wherein said combined motor and alternator device includes a magnetic rotor embedded within said first rotatable shaft.

16. The gas turbine engine of claim 10, where said combined motor and alternator device is disposed within a bearing system located on said first rotatable shaft between said high pressure turbine and said high pressure compressor.

17. The gas turbine engine of claim 10, wherein said combined motor and alternator device is coupled to said high pressure compressor.

18. The gas turbine engine according to claim 10, further comprising:
said free turbine including a variable area turbine nozzle for controlling fuel consumption.

19. The gas turbine engine of claim 10, where said combined motor and alternator device is electrically coupled to an electrical system of a vehicle.

20. A method of starting a gas turbine engine of a type having a high pressure spool, a low pressure spool, and a combustor for receiving high pressure airflow from a high pressure compressor of the high pressure spool and delivering a heated air flow to a high pressure turbine of said high pressure spool, said method comprising:
imparting rotation to a rotatable shaft rotatably coupling a rotor of the high pressure compressor and the high pressure turbine to start said gas turbine engine;
said step of imparting rotation selected from:
delivering a pressurized motive fluid to a starter turbine coupled to the rotatable shaft; and
delivering a rotational force to the first shaft using a combined motor and alternator device.

21. The method of claim 20, wherein said motive fluid is selected from the group consisting of air and a hydraulic fluid.

22. The method of claim 20, further comprising:
said step of imparting rotation including electrically coupling said combined motor and alternator device to a power supply of a vehicle; and
after starting said gas turbine engine, using said combined motor and alternator device to convert rotational energy of the rotatable shaft to electrical energy.
